(19) United States
(12) Patent Application Publication
(10) Pub. No.: US 2023/0331558 A1
(43) Pub. Date: Oct. 19, 2023

(54) METHOD FOR EXFOLIATING AND/OR FUNCTIONALISING LAMELLAR OBJECTS AND ASSOCIATED DEVICE

(71) Applicants: UNIVERSITE DE LORRAINE, Nancy (FR); CENTRE NATIONAL DE LA RECHERCHE SCIENTIFIQUE, Paris (FR)

(72) Inventors: Stéphane CUYNET, Nancy (FR); Marc PONCOT, Saulxures Les Nancy (FR); Sébastien FONTANA, Heillecourt (FR); Adrien LÉTOFFÉ, Septmonts (FR); Gérard HENRION, Nancy cedex (FR); Claire HEROLD, Laxou (FR); Isabelle ROYAUD, Frouard (FR); Thierry BELMONTE, Neuves-Maisons (FR)

(21) Appl. No.: 17/905,358

(22) PCT Filed: Mar. 10, 2021
(86) PCT No.: PCT/EP2021/056115

§ 371 Date: Aug. 31, 2022

(30) Foreign Application Priority Data
Mar. 12, 2020 (FR) FR2002479

(51) Int. Cl. C01B 32/194; C01B 32/225; C01B 32/19; B01J 19/08

(52) U.S. Cl. CPC C01B 32/194; C01B 32/225; C01B 32/19; B01J 19/088; C01B 2204/32; C01P 2002/82; B01J 2219/0896; B01J 2219/089; B01J 2219/0809

(57) ABSTRACT

A method for exfoliating and/or functionalising lamellar objects is discussed. The steps include immersing at least one portion of a first electrode in a liquid containing the lamellar objects to be exfoliated and/or functionalised, placing a second electrode outside the liquid, at least one portion of the second electrode being opposite a surface of the liquid, generating a plasma between at least one portion of the second electrode facing the surface of the liquid and the surface of the liquid by applying a pulse voltage difference between the first and the second electrode.

### TECHNICAL FIELD

The present invention relates to the field of producing nanofillers intended to be incorporated within composite materials, in particular polymer composites. Such nanofillers are, in particular, lamellar materials such as, for example, graphene or graphene materials.

The present invention also relates to the treatment, and in particular the exfoliation and/or the functionalization, of such nanofillers.

### STATE OF THE PRIOR ART

The wet functionalization of lamellar materials by chemical acid and/or oxidizing treatment is known from the state of the prior art. Such treatments require the use of harmful chemical compounds which necessitate strict operating conditions and have a significant environmental impact.

The functionalization of lamellar materials by plasma treatment is also known from the state of the prior art. These plasma treatment processes involve the interaction of the plasma with the surfaces of the material to be treated, resulting in the reaction of the reactive species of the plasma with the material to be treated.

Techniques for exfoliating lamellar materials by sonication are known from the state of the prior art. This method offers limited efficiency, as it requires several steps in order to obtain the desired result.

Also found in the state of the art is micromechanical exfoliation, by means of which sheets of graphene are mechanically separated by detachment of one sheet or a group of sheets of graphite or of graphene materials. Such an approach is not viable on an industrial scale.

An aim of the invention is in particular:
to dispense with the use of chemical compounds which are harmful or have a substantial environmental impact, and/or
to obtain lamellar materials with few layers, and/or
to obtain lamellar materials with few layers starting from macroscopic lamellar materials, and/or
to functionalize lamellar materials, and/or
to obtain lamellar materials in a single step and/or to functionalize lamellar materials in a single step and/or to obtain functionalized lamellar materials in a single step, and/or
to introduce few structural defects into the lamellar materials obtained and/or into the functionalized lamellar materials obtained, and/or
to be not very energy-intensive, but easy and simple to implement, and/or
to control the lamellar materials obtained and/or the functionalized lamellar materials obtained.

### Presentation of the Invention

To this end, a method for exfoliating and/or functionalizing lamellar objects is proposed, comprising the steps of:
immersing at least one portion of a first electrode in a liquid containing the lamellar objects to be exfoliated and/or to be functionalized,
placing a second electrode outside the liquid; at least one portion of the second electrode being opposite a surface of the liquid,
generating a plasma between the at least one portion of the second electrode opposite the surface of the liquid and said surface of the liquid by applying a voltage difference between the first electrode and the second electrode.

Preferably, a voltage of the first electrode is greater than a voltage of the second electrode.

The voltage of the first electrode can be smaller than the voltage of the second electrode, in order that the exfoliation is greater than the functionalization. The voltage of the first electrode can be smaller than the voltage of the second electrode, in order to decrease or no longer obtain functionalization. In other words, the voltage of the first electrode can be smaller than the voltage of the second electrode, in order that the exfoliation of the lamellar objects is carried out, predominantly or exclusively, during the implementation of the method.

According to the invention, by lamellar is meant an object the structure of which comprises parallel sheets.

The second electrode and/or a portion of the first electrode can be placed in a gas in contact with the surface of the liquid.

The at least one portion of the second electrode opposite the surface of the liquid can be:
an end of the second electrode, and/or
all or part of a surface of the electrode located opposite the surface of the liquid.

According to the invention:
the voltage difference between the first electrode and the second electrode is greater than 1000 volts, and/or
a distance d1 between the at least one portion of the second electrode opposite the surface of the liquid and the surface of the liquid is greater than 1 μm, and/or
an application time of the voltage difference between the first electrode and the second electrode is longer than 10 picoseconds, and/or
a time interval between two successive applications of the voltage difference between the first electrode and the second electrode is longer than 0.1 ns, and/or
a pressure of a gas in which the second electrode is placed is greater than 1 pascal (Pa) and/or smaller than 1.10⁷ Pa.

Preferably, the voltage difference between the first electrode and the second electrode can be adapted as a function of the product of the pressure of the gas and the distance d1, or vice versa, in order that a plasma is generated, i.e. in order to satisfy the breakdown conditions of the gas.

Preferably, the gas in which the second electrode is placed is the gas in contact with the surface of the liquid.

The gas in which the second electrode is placed can be, by way of non-limitative example, air, nitrogen, a noble gas, such as for example xenon, krypton, argon, neon or helium, or a mixture of gases.

The first electrode and/or the second electrode can comprise, preferably in a predominant proportion, a refractory material.

The first electrode and/or the second electrode can be constituted, predominantly or essentially, by a refractory material.

The first and second electrodes can comprise tungsten and/or carbon.

The lamellar objects to be exfoliated and/or to be functionalized can comprise graphite, a clay material, transition metal chalcogenides, phyllosilicates and/or a graphene material.

Preferably, the lamellar objects to be exfoliated and/or to be functionalized comprise, predominantly or essentially, graphite, a clay material, transition metal chalcogenides, phyllosilicates and/or a graphene material. The lamellar objects to be exfoliated and/or to be functionalized can be constituted, predominantly or essentially, by graphite, by a clay material, by transition metal chalcogenides, by phyllosilicates and/or by a graphene material.

According to the invention, the exfoliated lamellar objects and/or the functionalized lamellar objects, have a number of layers smaller than 25.

The lamellar objects to be exfoliated and/or to be functionalized can comprise graphite and/or a graphene material and the exfoliated and/or functionalized objects can be made of graphene.

Graphene is considered, within the framework of the present application, as being composed of a number of sheets smaller than 25.

The lamellar objects to be exfoliated and/or to be functionalized can have at least one dimension greater than 100 nanometres.

The lamellar objects to be functionalized and/or to be exfoliated can have a single dimension greater than 100 nanometres or two dimensions greater than 100 nanometres or three dimensions greater than 100 nanometres.

The method can comprise an adjustment:
of the voltage difference between the first electrode and the second electrode so as to:
increase the exfoliation and/or the functionalization of the lamellar objects contained in the liquid by increasing or decreasing the voltage difference between the first electrode and the second electrode, and/or
decrease the exfoliation and/or the functionalization of the lamellar objects contained in the liquid by decreasing or increasing the voltage difference between the first electrode and the second electrode, and/or
of a nature of the gas in which the second electrode is placed and/or of the pressure of the gas in which the second electrode is placed so as to:
increase the exfoliation and/or the functionalization of the lamellar objects contained in the liquid by decreasing a breakdown voltage in the gas, and/or
decrease the exfoliation and/or the functionalization of the lamellar objects contained in the liquid by increasing the breakdown voltage in the gas, and/or
of a nature of the liquid containing the lamellar objects to be exfoliated and/or to be functionalized and/or of a conductivity of the liquid containing the lamellar objects to be exfoliated and/or to be functionalized so as to:
increase the exfoliation and/or the functionalization of the lamellar objects contained in the liquid by decreasing the pH through the addition of one or more acids and/or by increasing the conductivity of the liquid through the addition of one or more salts, and/or
decrease the exfoliation and/or the functionalization of the lamellar objects contained in the liquid by increasing the pH through the addition of one or more bases and/or by decreasing the conductivity of the liquid through a decrease in the salinity of the solution, and/or
of a surface area of the second electrode so as to:
increase the exfoliation and/or the functionalization of the lamellar objects contained in the liquid by increasing the surface area of the second electrode which interacts with the plasma, and/or
decrease the exfoliation and/or the functionalization of the lamellar objects contained in the liquid by decreasing the surface area leaking and/or collecting electrical charges which interacts with the plasma.

Preferably, and unless otherwise indicated in the present application, the adjustment of a parameter which has the effect of increasing the exfoliation and/or the functionalization (or respectively of decreasing the exfoliation and/or the functionalization) does not have the effect of decreasing the exfoliation and/or the functionalization (or respectively of increasing the exfoliation and/or the functionalization).

By acid can be meant a species which can behave like an acid during an acid-base reaction and by base can be meant a species capable of behaving like a base during an acid-base reaction. In particular, by base can be meant a chemical species capable of accepting one or more protons (H⁺) and by base can be meant a chemical species capable of donating one or more protons (H⁺).

According to the invention, an adjustment can be a modification or an adaptation.

According to the invention, increasing or decreasing the exfoliation and/or the functionalization can be defined as increasing or decreasing a rate of exfoliation and/or a rate of functionalization.

Preferably, the method can be implemented at atmospheric pressure.

The method can comprise an adjustment:
of the distance d1 between the at least one portion of the second electrode opposite the surface of the liquid and the surface of the liquid so as to:
increase the exfoliation and/or the functionalization, by promoting a homogeneous regime or a filamentary regime, of the lamellar objects contained in the liquid by decreasing the distance between the at least one portion of the second electrode opposite the surface of the liquid and the surface of the liquid, and/or
decrease the exfoliation and/or the functionalization, by promoting a filamentary regime or a homogeneous regime, of the lamellar objects contained in the liquid by increasing the distance between the at least one portion of the second electrode opposite the surface of the liquid and the surface of the liquid, and/or
of the application time of the voltage difference between the first electrode and the second electrode so as to:
increase the exfoliation and/or the functionalization of the lamellar objects contained in the liquid by increasing the application time of the voltage between the first electrode and the second electrode, and/or
decrease the exfoliation and/or the functionalization of the lamellar objects contained in the liquid by decreasing the application time of the voltage between the first electrode and the second electrode, and/or
of the frequency between two successive applications of the voltage difference so as to:
increase the exfoliation and/or the functionalization of the lamellar objects contained in the liquid by increasing the frequency between two successive applications of the voltage difference, and/or
decrease the exfoliation and/or the functionalization of the lamellar objects contained in the liquid by decreasing the frequency between two successive applications of the voltage difference.

In the case of the adjustment of the distance d1, decreasing the distance d1 can have the same effect, by way of non-limitative example of increasing the functionalization, as increasing the distance d1. This effect is due to the change in plasma discharge regime, for example of the passage from a homogeneous discharge regime to a filamentary discharge regime or vice versa.

According to the invention, a device is also proposed for exfoliating and/or functionalizing lamellar objects comprising:
at least one first electrode comprising at least one portion intended to be immersed in a liquid containing the lamellar objects to be exfoliated and/or to be functionalized,
at least one second electrode intended to be placed outside the liquid; at least one portion of the at least one second electrode being intended to be opposite a surface of the liquid,
a pulsed power generator for emitting electrical pulses between the at least one first electrode and the at least one second electrode, said pulsed power generator being arranged in order to apply a voltage difference greater than 1000 volts between the at least one first electrode and the at least one second electrode.

Preferably, the at least one first and second electrodes are placed relative to one another and/or the generator is arranged such that no plasma is generated between the at least one first electrode and the at least one second electrode.

Preferably, no plasma extends between a surface of the at least one first electrode and a surface of the at least one second electrode. The surface of the at least one second electrode can be the at least one portion of the at least one second electrode intended to be placed opposite the surface of the liquid.

Preferably, the at least one first and second electrodes are placed relative to one another and/or the generator is arranged such that a plasma is generated starting from the at least one portion of the at least one second electrode intended to be placed opposite the surface of the liquid. Preferably, the plasma is generated starting from the at least one portion of the at least one second electrode opposite the surface of the liquid to a surface of the liquid in which the at least one portion of the at least one first electrode is intended to be immersed.

The at least one first and second electrodes can be arranged with respect to one another such that a distance d2 separating said at least one first and second electrodes is greater than a distance, denoted d_{E1E2}, starting from and below which a plasma is generated in the area of space extending between the at least one first and second electrodes along the distance d_{E1E2}, and/or
the generator can be arranged in order to apply a voltage V between the at least one first and second electrodes which is smaller than the voltage, denoted V_{cl-elec}, for which a plasma is generated in the area extending between the at least one first and second electrodes along the distance d2.

Preferably, for a given gas and pressure of the gas:
and for a voltage difference, denoted Vₐₚₚ, applied between the at least one first and second electrodes, the arrangement of the at least one first and second electrodes with respect to one another is such that the distance d2 between said at least one first and second electrodes is greater than the distance, denoted d_{E1E2}, separating the at least one first and second electrodes, starting from and below which a plasma is generated in the area of space extending between the at least one first and second electrodes along the distance d_{E1E2}, and/or
for an arrangement of the at least one first and second electrodes with respect to one another such that said at least one first and second electrodes are separated by a given distance, denoted d_{cl-elec}, the generator is arranged in order to apply a voltage V between the at least one first and second electrodes which is smaller than the voltage, denoted V_{cl-elec}, for which a plasma is generated in the area extending between the at least one first and second electrodes along the distance d2.

Preferably, the arrangement of the at least one first and second electrodes and/or the voltage V applied between the at least one first and second electrodes are such that a breakdown voltage of the gas, V_{cl-elec}, in the area of space extending between the at least one first and second electrodes along the distance d2, is greater than the breakdown voltage of the gas, called V_{cl-liq}, in the area of space extending between the at least one portion of the at least one second electrode intended to be placed opposite the surface of the liquid and the surface of the liquid along the distance d1.

In other words, the voltage difference applied between the at least one first electrode and the at least one second electrode and/or the arrangement of the at least one first and second electrodes with respect to one another are such that no plasma is generated in the area of space extending between the at least one first electrode and the at least one second electrode.

Preferably, only one portion, called the emerged portion, of the second electrode is intended to be placed in the gas.

According to the invention, by “placed an object, for example a portion of an electrode, in a medium, for example a gas or a liquid” is meant a direct contact of a surface of the object with the medium.

By way of non-limitative example, the at least one first electrode and/or the at least one second electrode can be in the form of an oblong or in the form of a plate.

The at least one first electrode and/or the at least one second electrode can be a single electrode or can comprise several electrodes.

The at least one first electrode and/or the at least one second electrode can be a group of electrodes connected to one another or not. The at least one first electrode and/or the at least one second electrode can be a network of electrodes.

The device can comprise a single generator or several generators.

The device can comprise several generators and the at least one first electrode and/or the at least one second electrode comprises, preferably, several electrodes; each generator being connected to a single electrode or to several electrodes of the several electrodes.

Preferably, a voltage of the first electrode is greater than a voltage of the second electrode.

The at least one first electrode can comprise:
a portion which is intended to be positioned in a gas in which the at least one second electrode is placed and which is separated from the at least one second electrode by a distance d2, said distance d2 being adapted as a function of a nature and/or of a pressure of the gas in which the at least one second electrode is placed such that the voltage difference applied by the generator is smaller than the breakdown voltage in the gas, or
an absence of the portion intended to be positioned in the gas in which the at least one second electrode is placed.

The distance d2 can be defined as the smallest distance separating the portion of the at least one first electrode intended to be positioned in the gas in which the at least one second electrode is placed and the at least one second electrode.

Preferably, the portion intended to be positioned in the gas in which the at least one second electrode is placed is the portion of the second electrode intended to be emerged.

A whole of the at least one first electrode can be intended to be immersed in the liquid. The absence of the portion of the at least one first electrode intended to be positioned in the gas can correspond to the case where the whole of the at least one first electrode is intended to be immersed in the liquid.

The at least one first electrode can be in the form of an oblong and:
extends primarily in a direction b1 connecting:
   a plane p1 comprising the at least one portion of the at least one second electrode intended to be placed opposite the surface of the liquid, and
   an end of the at least one portion of the at least one first electrode intended to be immersed in the liquid,
a portion of the at least one first electrode, comprising the at least one portion of the at least one first electrode intended to be immersed in the liquid, projects in the direction b1 with respect to the plane p1; a distance d3 between the end of the at least one portion of the at least one first electrode intended to be immersed in the liquid and the plane p1 is greater than 2 mm.

The at least one second electrode and/or the at least one first electrode and the at least one second electrode can be in the form of an oblong.

According to the invention:
a distance d1 between the plane p1 and the surface of the liquid can be greater than 1 μm, and
a distance d4, equal to the difference between d3 and d1, between a plane p2 comprising the end of the at least one portion of the at least one first electrode intended to be immersed in the liquid and the surface of the liquid can be greater than 1 mm.

The device can comprise the liquid containing the lamellar objects to be exfoliated and/or to be functionalized; the at least one first and second electrodes are placed relative to one another and/or the generator is arranged in order to apply a voltage difference adapted so as to generate a plasma between the at least one portion of the at least one second electrode placed opposite the surface of the liquid and said surface of the liquid.

Preferably, the arrangement of the at least one first and second electrodes and/or the voltage V applied between the at least one first and second electrodes are such:
that a breakdown voltage of the gas, V_{cl-elec}, in the area of space extending between the at least one first and second electrodes along the distance d2 is greater than the breakdown voltage of the gas, called V_{cl-liq}, in the area of space extending between the at least one portion of the at least one second electrode intended to be placed opposite the surface of the liquid and the surface of the liquid along the distance d2, and
that the voltage V applied between the at least one first and second electrodes is:
   greater than the voltage V_{cl-liq}, and
   smaller than the voltage V_{cl-elec}.

The device according to the invention is, preferably, arranged in order to implement the method according to the invention. Any characteristic of the method according to the invention can be integrated in the device according to the invention.

Preferably, the method according to the invention is implemented by the device according to the invention. Any characteristic of the device according to the invention can be integrated in the method according to the invention.

### DESCRIPTION OF THE FIGURES

Other advantages and features of the invention will become apparent on reading the detailed description of implementations and embodiments which are in no way limitative, and the following attached drawings:

FIG. 1 is a diagrammatic representation of an embodiment of the device according to the invention,

FIG. 2 is a graph illustrating the evolution of the pH of the solution, the electrical conductivity of the solution and the temperature of the solution as a function of the time during which the method according to the invention is implemented,

FIG. 3 shows photos comparing lamellar fillers treated by the method in suspension and reference lamellar fillers in suspension,

FIG. 4 shows a Raman spectrum of lamellar fillers before treatment and a Raman spectrum of lamellar fillers after treatment.

### DESCRIPTION OF THE EMBODIMENTS

As the embodiments described below are in no way limitative, variants of the invention can in particular be considered comprising only a selection of the characteristics described, in isolation from the other characteristics described (even if this selection is isolated within a sentence comprising these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

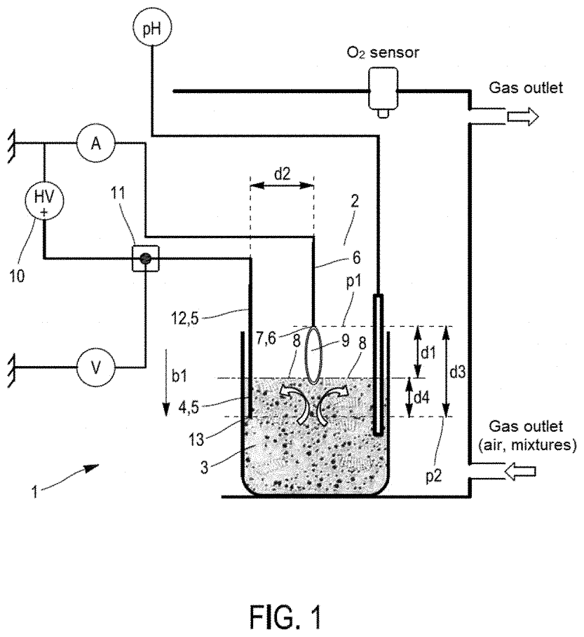

The device 1 and the method according to the invention are described with reference to FIG. 1. The lamellar objects used during the implementation of the exfoliating and/or functionalizing method according to the invention by means of the device 1 are graphite fillers sold under the commercial name “KNG-180” by the company “Knano”. The graphite fillers have a macroscopic size the dimensions of which are greater than 100 nanometres. The exfoliated and/or functionalized objects are made of graphene. The exfoliated and/or functionalized objects can comprise graphene and graphene materials. The method is implemented at ambient temperature. The gas 2 in which at least one second electrode 6, a single second electrode 6 according to the embodiment, is intended to be placed is air 2. The pressure of the gas 2 in which the second electrode 6 is placed is greater than 1 pascal (Pa) and/or smaller than 1.10⁷ Pa. According to the embodiment, the air 2 is at atmospheric pressure. The liquid 3 containing the lamellar objects and in which the at least one portion 4 of at least one first electrode 5, a single first electrode 5 according to the embodiment, is intended to be immersed is demineralized water 3. The method is implemented on solutions of which the liquid volume 3 is 300 ml and the mass of the graphite fillers is 200 mg. Unless otherwise indicated, the method is implemented over one hour. The second electrode 6 is intended to be placed outside the liquid 3. At least one portion 7 of the second electrode 6 is intended to be opposite the surface 8 of the liquid 3. The device 1 comprises a pulsed power generator 10 emitting electrical pulses between the first electrode 5 and the second electrode 6. The pulsed generator 10 is arranged in order to apply a voltage difference greater than 1000 volts between the first electrode 5 and the second electrode 6. The voltage difference is 6 kV according to the embodiment. Preferably, the voltage of the first electrode 5 is greater than the voltage of the second electrode 6. According to the embodiment, the second electrode 6 is connected to ground and the first electrode 5 is connected to the pulsed generator 10.

When the method is implemented, the portion 4 of the first electrode 5 is immersed in the liquid 3. The first 5 and second 6 electrodes are placed relative to one another and/or the generator 10 is arranged in order to apply a voltage difference adapted in order to generate a plasma 9 between the portion 7 of the second electrode 6 placed opposite the surface 8 of the liquid 3 and said surface 8 of the liquid 3. In practice, the initiation of the plasma, which is called breakdown, occurs under conditions which obey Paschen's law, i.e. when the product of the pressure of the gas and the distance between the electrodes minimizes the breakdown voltage of the gas. Typically, a distance of a few millimetres between the second electrode 5 and the surface 8 of the liquid 3, coupled with a greater voltage than the breakdown voltage, are chosen in order to ensure a plasma discharge 9 in a mixture of gases 2 or in pure gas 2.

The first 5 and second 6 electrodes are placed relative to one another and/or the generator 10 is arranged such that no plasma is generated between the first electrode 5 and the second electrode 6. A plasma 9 is generated between the portion 7 of the second electrode 6 opposite the surface 8 of the liquid 3 and the surface 8 of the liquid 3 by applying a voltage difference between the first electrode 5 and the second electrode 6. By way of non-limitative example, the plasma generated according to the invention has a size of approximately 1 mm³, and can be considered as a plasma with a small size. A plasma with a size of 10 cm³ or with a larger size can be considered as a plasma with a large size.

The distance d1 between the portion 7 of the second electrode 6 intended to be opposite the surface 8 of the liquid 3 and the surface 8 of the liquid 3 is greater than 1 μm, according to the embodiment it is 1 mm. The device 1 comprises a nanosecond chopper 11 which is arranged in order to apply the voltage between the first electrode 5 and the second electrode 6 for an application time which is longer than 10 picoseconds. The application time is 1 μs according to the invention. The average electrical power of the pulse is approximately 36 W. The nanosecond chopper 11 is arranged such that a time interval between two successive applications of the voltage difference between the first 5 and the second 6 electrodes is preferably longer than 0.1 ns. This time interval is approximately 170 μs according to the embodiment. The benefit of the high-voltage pulsed regime (typically with voltages greater than 1000 volts) is to promote the process of exfoliating the graphite by igniting shock waves during the plasma breakdown 9 in the air 2 at atmospheric pressure. The graphite fillers located on the surface 8 of the liquid 3 can then undergo a mechanical detachment of their graphene planes. The other benefit of this discharge regime is to allow a high-energy plasma functionalization while having a method which is not very energy-intensive, with an average power comprised between 10 and 120 W as a function of the discharge conditions. By necessitating only the breakdown voltage of the gas 2 (air here), the method is allowed to progress until currents of a few amps are achieved.

A portion 12 of the first electrode 5 is intended to be positioned in the gas 3 in which the second electrode 6 is placed. The portion 12 is separated from the second electrode 6 by a distance d2. The distance d2 is adapted as a function of the nature and/or of the pressure of the gas in which the second electrode 6 is placed such that the voltage difference applied by the generator 10 is smaller than the breakdown voltage in the gas.

According to the embodiment, the first electrode 5 and the second electrode 6 are in the form of an oblong. The first electrode 5 extends primarily in a direction b1 connecting:
the plane p1 comprising the portion 7 of the second electrode 6 intended to be placed opposite the surface 8 of the liquid 3, and
the end 13 of the portion 4 of the first electrode 5 intended to be immersed in the liquid 3.
   A portion of the first electrode 5, comprising the portion 4 of the first electrode 5 intended to be immersed in the liquid 3, projects in the direction b1 with respect to the plane p1. The distance d3 between the end 13 of the portion 4 of the first electrode 5 intended to be immersed in the liquid 3 and the plane p1 is greater than 2 mm. The distance d4, equal to the difference between d3 and d1, between a plane p2 comprising the end 13 of the portion 4 of the first electrode 5 intended to be immersed in the liquid 3 and the surface of the liquid 3 is greater than 1 mm.

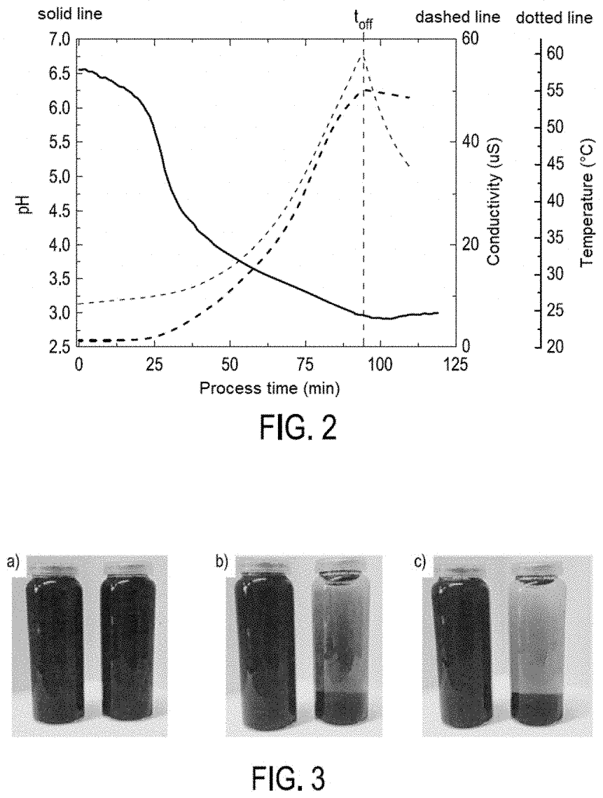

The effect of the method on the solution 3 is described with reference to FIG. 2. The aqueous phase 3 will undergo significant changes with regard to its initial intrinsic properties, in particular with regard to its composition, which will modify its pH and its electrical conductivity. This change in composition of the liquid 3 is, in particular, due to the interactions between the plasma 9 and the liquid 3 and more particularly to the progressive solvation on the surface 8 of the liquid 3 of the species originating from the plasma 9, such as the electrons, the ions and other radicals or energy species. The evolution of the medium 3, its acidification and its progressive temperature rise are equally variable parameters, which also promote the processes of exfoliating the graphite on the surface and in the volume of the liquid 3, as well as the reaction mechanisms for functionalizing the graphene planes.

The efficiency of the functionalizing effect of the method on the graphene nanofillers obtained is presented with reference to FIG. 3. The sedimentation rate of a suspension of nanofillers is an indicator of the surface condition of the nanofillers in suspension. The functionalization of the nanofillers introduces chemical, in particular polar, groups or functions at the surface of the nanofillers, in particular containing oxygen atoms, for example hydroxyls, carbonyls and/or carboxyls which promote the suspension and the stability of nanofillers. In each of FIGS. 3a), 3b) and 3c), the sample on the left is an aqueous solution in which the nanofillers obtained by the method are in suspension and the sample on the right is an aqueous solution in which nanofillers sold under the commercial name “KNG-180” by the company “Knano” are in suspension. FIGS. 3a), 3b) and 3c) show, respectively, the images of the samples immediately after stirring, 5 minutes after stirring and 1 hour after stirring. After 1 hour, no appreciable sedimentation is observed on the samples containing the nanofillers, in suspension, obtained by the method, while after 5 minutes a significant sedimentation is observed for the solution containing the reference nanofillers in suspension. This demonstrates the efficiency of the method for functionalizing the nanofillers according to the invention. This modification of the surface condition of the fillers is also confirmed by the detection of carboxylic groups on the surface of the graphene planes revealed by thermogravimetric analyses coupled with mass spectrometry and X-ray photoelectron spectrometry analysis. These groups can, thereafter, be used for specific functionalization treatments or to promote the dispersion of the graphene planes within a polymer matrix.

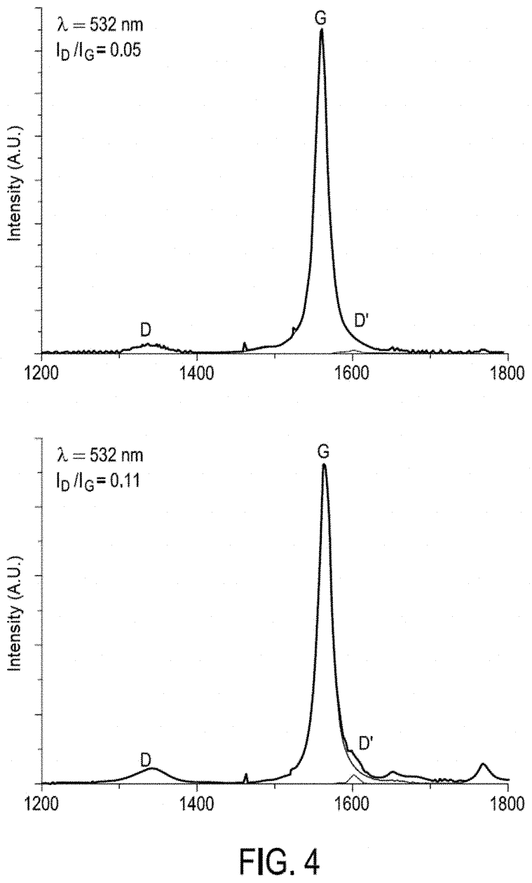

With reference to FIG. 4, the Raman spectrum of the initial graphite fillers before implementation of the method is illustrated in the left-hand FIGURE. The Raman spectrum of the graphene nanofillers obtained after implementation of the method is presented in the right-hand FIGURE. A small degradation of the carbon planes, which is ten times smaller than that observed at the end of the chemical treatments of the state of the art, is noted. The “defect ratio” is appraised through the ratio denoted “I_{D}/I_{G}”, which is equal to the ratio of the spectral band denoted D, characteristic of the defects, to the spectral band denoted G, characteristic of the sp2 hybridization state of the carbon.

Thus, in variants which can be combined with one another of the embodiments described above:
the lamellar objects to be exfoliated and/or to be functionalized comprise a clay material, transition metal chalcogenides, phyllosilicates and/or a graphene material, and/or
the first electrode 5 and the second electrode 6 comprise, preferably in a predominant proportion, a refractory material, and/or
the first electrode 5 and the second electrode 6 comprise tungsten and/or carbon, and/or
the first electrode 5 is totally immersed in the liquid 3; the first electrode 5 therefore does not comprise a portion 12 intended to be positioned in the gas 2 in which the second electrode 6 is placed.

Moreover, the different characteristics, forms, variants and embodiments of the invention can be combined together in various combinations unless they are incompatible or mutually exclusive.

1. A method for exfoliating and/or functionalizing lamellar objects comprising the steps of:
immersing at least one portion of a first electrode in a liquid containing the lamellar objects to be exfoliated and/or to be functionalized;
placing a second electrode outside the liquid; at least one portion of the second electrode being opposite a surface of the liquid; and
generating a plasma between the at least one portion of the second electrode opposite the surface of the liquid and said surface of the liquid by applying a pulse voltage difference between the first electrode and the second electrode.

2. The method according to claim 1, in which:
the voltage difference between the first electrode and the second electrode is greater than 1000 volts, and/or
a distance d1 between the at least one portion of the second electrode opposite the surface of the liquid and the surface of the liquid is greater than 1 μm, and/or
an application time of the voltage difference between the first electrode and the second electrode is longer than 10 picoseconds, and/or
a time interval between two successive applications of the pulse voltage difference between the first electrode and the second electrode is longer than 0.1 ns, and/or
a pressure of a gas in which the second electrode is placed is greater than 1 pascal (Pa) and/or smaller than 1.10⁷ Pa.

3. The method according to claim 1, in which the first electrode and/or the second electrode comprises, preferably in a predominant proportion, a refractory material.

4. The method according to claim 1, in which the first and second electrodes comprise tungsten and/or carbon.

5. The method according to claim 1, in which the lamellar objects to be exfoliated and/or to be functionalized comprise graphite, a clay material, transition metal chalcogenides, phyllosilicates and/or a graphene material.

6. The method according to claim 1, in which the lamellar objects to be exfoliated and/or to be functionalized comprise graphite and/or a graphene material and in which the exfoliated and/or functionalized objects are made of graphene.

7. The method according to claim 1, in which the lamellar objects to be exfoliated and/or to be functionalized have at least one dimension greater than 100 nanometres.

8. The method according to claim 1, comprising an adjustment:
of the voltage difference between the first electrode and the second electrode so as to:
increase the exfoliation and/or the functionalization of the lamellar objects contained in the liquid by increasing or decreasing the voltage difference between the first electrode and the second electrode, and/or
decrease the exfoliation and/or the functionalization of the lamellar objects contained in the liquid by decreasing or increasing the voltage difference between the first electrode and the second electrode, and/or
of a nature of the gas in which the second electrode is placed and/or of the pressure of the gas in which the second electrode is placed so as to:
increase the exfoliation and/or the functionalization of the lamellar objects contained in the liquid by decreasing a breakdown voltage in the gas, and/or
decrease the exfoliation and/or the functionalization of the lamellar objects contained in the liquid by increasing the breakdown voltage in the gas, and/or
of a nature of the liquid containing the lamellar objects to be exfoliated and/or to be functionalized and/or of a conductivity of the liquid containing the lamellar objects to be exfoliated and/or to be functionalized so as to:
increase the exfoliation and/or the functionalization of the lamellar objects contained in the liquid by decreasing the pH through the addition of one or more acids and/or by increasing the conductivity of the liquid through the addition of one or more salts, and/or
decrease the exfoliation and/or the functionalization of the lamellar objects contained in the liquid by increasing the pH through the addition of one or more bases and/or by decreasing the conductivity of the liquid through a decrease in the salinity of the solution.

9. The method according to claim 2, comprising an adjustment:
of the application time of the voltage difference between the first electrode and the second electrode so as to:
increase the exfoliation and/or the functionalization of the lamellar objects contained in the liquid by increasing the application time of the voltage between the first electrode and the second electrode, and/or
decrease the exfoliation and/or the functionalization of the lamellar objects contained in the liquid by decreasing the application time of the voltage between the first electrode and the second electrode, and/or
of the frequency between two successive applications of the voltage difference so as to:
increase the exfoliation and/or the functionalization of the lamellar objects contained in the liquid by increasing the frequency between two successive applications of the voltage difference, and/or
decrease the exfoliation and/or the functionalization of the lamellar objects contained in the liquid by decreasing the frequency between two successive applications of the voltage difference.

10. A device for exfoliating and/or functionalizing lamellar objects comprising:
at least one first electrode comprising at least one portion intended to be immersed in a liquid containing the lamellar objects to be exfoliated and/or to be functionalized,
at least one second electrode intended to be placed outside the liquid; at least one portion of the at least one second electrode being intended to be opposite a surface of the liquid,
a pulsed power generator for emitting electrical pulses between the at least one first electrode and the at least one second electrode, said pulsed power generator being arranged in order to apply a voltage difference greater than 1000 volts between the at least one first electrode and the at least one second electrode; the at least one first and second electrodes are placed relative to one another and/or the generator is arranged such that no plasma is generated between the at least one first electrode and the at least one second electrode.

11. The device according to claim 10, in which the at least one first electrode comprises:
a portion which is intended to be positioned in a gas in which the at least one second electrode is placed and which is separated from the at least one second electrode by a distance d2, said distance d2 being adapted as a function of a nature and/or of a pressure of the gas in which the at least one second electrode is placed such that the voltage difference applied by the generator is smaller than the breakdown voltage in the gas, or
an absence of the portion intended to be positioned in the gas in which the at least one second electrode is placed.

12. The device according to claim 10, in which the at least one first electrode is in the form of an oblong and:
extends primarily in a direction b1 connecting:
a plane p1 comprising the at least one portion of the at least one second electrode intended to be placed opposite the surface of the liquid, and
an end of the at least one portion of the at least one first electrode intended to be immersed in the liquid,
a portion of the at least one first electrode, comprising the at least one portion of the at least one first electrode intended to be immersed in the liquid, projects in the direction b1 with respect to the plane p1; a distance d3 between the end of the at least one portion of the at least one first electrode intended to be immersed in the liquid and the plane p1 is greater than 2 mm.

13. The device according to claim 10, in which:
a distance d1 between the plane p1 and the surface of the liquid is greater than 1 μm, and
a distance d4, equal to the difference between d3 and d1, between a plane p2 comprising the end of the at least one portion of the at least one first electrode intended to be immersed in the liquid and the surface of the liquid is greater than 1 mm.

14. The device according to claim 10, comprising the liquid containing the lamellar objects to be exfoliated and/or functionalized; the at least one first and second electrodes are placed relative to one another so as to, and/or the generator is arranged in order to, apply a voltage difference adapted so as to generate a plasma between the at least one portion of the at least one second electrode placed opposite the surface of the liquid and said surface of the liquid.
